(19) United States
(12) Patent Application Publication
(10) Pub. No.: US 2026/0314806 A1
(43) Pub. Date: Oct. 15, 2026

(54) CANTILEVER ROLLER BRUSH ASSEMBLY AND CLEANING DEVICE

(71) Applicants: Yunjing Intelligence Innovation (Shenzhen) Co., Ltd., Shenzhen (CN); Yunjing Intelligence (Shenzhen) Co., Ltd., Shenzhen (CN)

(72) Inventors: Xu CHEN, Shenzhen (CN); Zhenxu WANG, Shenzhen (CN); Yuwei GUO, Shenzhen (CN); Weijin Lin, Shenzhen (CN); Shaojun YAN, Shenzhen (CN)

(21) Appl. No.: 19/467,717

(22) Filed: Feb. 2, 2026

Related U.S. Application Data
(63) Continuation-in-part of application No. PCT/CN2024/107253, filed on Jul. 24, 2024.

(30) Foreign Application Priority Data
Aug. 1, 2023 (CN) 202310963236.4
Aug. 1, 2023 (CN) 202322054732.6
Aug. 1, 2023 (CN) 202322065518.0
Aug. 1, 2023 (CN) 202322072557.3

(51) Int. Cl. A46B 5/00; A46B 13/00; A46B 13/02; A47L 9/04

(52) U.S. Cl. CPC A46B 5/0095; A46B 13/001; A46B 13/02; A47L 9/0477; A46B 2200/3033

(57) ABSTRACT

The present disclosure provides a cantilever roller brush assembly for a cleaning device. The cantilever roller brush assembly includes a mounting bracket and a cantilever roller brush. The suction chamber assembly includes a suction chamber and a mounting bracket. The cantilever roller brush includes a fixing end and a free end, the fixing end of the cantilever roller brush is rotatably connected to the mounting bracket, and the free end of the cantilever roller brush extends from the fixing end of the cantilever roller brush along the length direction of the cantilever roller brush, and the cantilever roller brush assembly is detachably fixed in the cleaning device through the mounting bracket.

### CROSS-REFERENCE TO RELATED APPLICATIONS

The present application claims the benefit of priority to Chinese Patent Application No. 202310963236.4, filed on Aug. 1, 2023, Chinese Patent Application No.202322054732.6, filed on Aug. 1, 2023, Chinese Patent Application No. 202322065518.0, filed on Aug. 1, 2023, and Chinese Patent Application No. 202322072557.3, filed on Aug. 1, 2023, the contents of which are all incorporated herein by reference in their entireties.

### BACKGROUND

The present disclosure relates to a roller brush assembly for a cleaning device, and a cleaning device. In particular, a roller brush assembly including a roller brush with a free end is disclosed herein.

Cleaning devices, for example, cleaning robots, can help user clean surfaces in a variety of different environments. With the equipment of a roller brush assembly and a vacuum system, most cleaning devices are able to take in debris and dust from a surface and guide them into a corresponding collector of the cleaning device. A conventional roller brush is fixed inside the cleaning device through its two ends. However, such a roller brush is complex in structure and inefficient in collecting hair or similar waste. In comparison, some cleaning devices use a cantilever roller brush, only one end of which is connected to the cleaning device, resolving the issues of structural complexity and efficiency. As a trade-off, such a cantilever roller brush is less stable than a conventional roller brush when the device is in operation, as the cantilever roller brush is connected with the cleaning device through only one mounting end. Thus, improvement of the cantilever roller brush is contemplated.

### SUMMARY

Embodiments of the present disclosure provide a suction chamber assembly for a cleaning device. The suction chamber assembly includes a suction chamber, a mounting bracket, and a roller brush. The suction chamber includes a basement connected to the cleaning device and a cap connected to the basement. The basement includes an outlet, and the cap includes an opening. The mounting bracket is detachably fixed to the suction chamber. The roller brush includes a fixing end connected with the mounting bracket and a free end extending opposite to the fixing end. The mounting bracket is fixed between the basement and the cap in the suction chamber by at least one pair of action force and reaction force applied to the mounting bracket and the suction chamber.

Embodiments of the present disclosure provide a suction chamber assembly for a cleaning device. The suction chamber assembly includes a suction chamber and a mounting bracket. The suction chamber includes a basement connected to the cleaning device and a cap connected to the basement. The basement includes an outlet, and the cap includes an opening. The mounting bracket includes a mounting base detachably fixed in the suction chamber and at least one supporting arm extending from an edge of the mounting base along the first direction. The at least one supporting arm is detachably fixed between the basement and the cap in the suction chamber by at least one pair of action force and reaction force applied between the basement of the suction chamber and at least one supporting arm.

Embodiments of the present disclosure also provide a cleaning device includes a chassis, a suction chamber connected to the chassis, a mounting bracket, and a roller brush. The suction chamber includes a basement connected to the cleaning device and a cap connected to the basement. The basement includes an outlet, and the cap includes an opening. The mounting bracket includes a mounting base detachably fixed in the suction chamber and at least one supporting arm extending from an edge of the mounting base along the first direction. The roller brush includes a fixing end connected with the mounting bracket and a free end extending opposite to the fixing end. The mounting bracket is fixed between the basement and the cap in the suction chamber by at least one pair of action force and reaction force applied between the mounting bracket and the basement of the suction chamber.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated herein and form a part of the specification, illustrate aspects of the present disclosure and, together with the description, further explain the present disclosure and to enable a person skilled in the pertinent art to make and use the present disclosure.

FIG. 1A illustrates a diagram of a cleaning device, according to some aspects of the present disclosure.

FIG. 1B illustrates a bottom view of the cleaning device shown in FIG. 1A, according to some aspects of the present disclosure.

FIG. 2A illustrates a roller brush assembly with a suction chamber of the cleaning device in a first state, according to some aspects of the present disclosure.

FIG. 2B illustrates the roller brush assembly with the suction chamber of the cleaning device in a second state, according to some aspects of the present disclosure.

FIG. 3 illustrates the roller brush assembly being outside the suction chamber of the cleaning device, according to some aspects of the present disclosure.

FIG. 4 illustrates the roller brush assembly of the cleaning device, according to some aspects of the present disclosure.

FIG. 5 illustrates a first exploded view of the roller brush assembly, according to some aspects of the present disclosure.

FIG. 6 illustrates a second exploded view of the roller brush assembly, according to some aspects of the present disclosure.

FIG. 7 illustrates a view of the roller brush assembly without the roller brush assembly, according to some aspects of the present disclosure.

FIG. 8 illustrates a cross-sectional view of the suction chamber, according to some aspects of the present disclosure.

FIG. 9 illustrates a structure of a cleaning assembly with a magnet assembly, according to some aspects of the present disclosure.

FIG. 10 illustrates a schematic block diagram of a cleaning assembly with a rotatable fastener assembly, according to some aspects of the present disclosure.

FIG. 11 illustrates a schematic block diagram of a cleaning assembly with a slotted fastener assembly, according to some aspects of the present disclosure.

FIG. 12 illustrates a schematic block diagram of a cleaning assembly with a spring fastener assembly, according to some aspects of the present disclosure.

FIG. 13 illustrates a schematic block diagram of a cleaning assembly with another spring fastener assembly, according to some aspects of the present disclosure.

FIG. 14 illustrates a schematic block diagram of a cleaning assembly with a screw thread assembly, according to some aspects of the present disclosure.

Aspects of the present disclosure will be described with reference to the accompanying drawings.

### DETAILED DESCRIPTION

Although specific configurations and arrangements are discussed, it should be understood that this is done for illustrative purpose only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part upon context. Further, the terms “comprises,” “comprising,” “including,” and “having” are intended to be inclusive and mean that there may be additional elements other than the listed elements.

Terms such as “upper,” “lower,” “inner,” “outer,” “front,” “rear,” and variations thereof herein are used for ease of description to explain the positioning of one element relative to a second element and are not intended to be limiting to a specific orientation or position.

Terms such as “first,” “second,” and variations thereof herein are used to describe various elements, regions, sections, etc. and are not intended to be limiting.

Terms such as “connect,” “couple,” “communication with,” and variations thereof herein are used broadly and encompass direct and indirect connections, communication and mountings, and are not restricted to electrical, physical, or mechanical attachments, connections, or mountings.

Now turn to the embodiments of the present disclosure, which teaches a novel way to improve the stability of a cantilever roller brush by providing a mounting bracket to connect the cantilever roller brush with the cleaning device, as opposed to the direct connection between the cantilever roller brush and the cleaning device. The cantilever roller brush is connected to the mounting bracket through at least one bearing, so that the mounting bracket is fixed to the cleaning device while the cantilever roller brush is able to rotate in a cleaning process. The stability of the cantilever roller brush may be greatly improved by a tailor-made structure of the mounting bracket, as shown in the present disclosure.

Additional novel features in part will be set forth in the following descriptions, and in part will become apparent to those skilled in the art upon examination of the following descriptions and the accompanying drawings or upon learning by implementing the examples taught herein. The novel features of the present disclosure may be realized and attained by practice or use of various aspects of the methodologies, instrumentalities, and combinations set forth in the detailed examples discussed below.

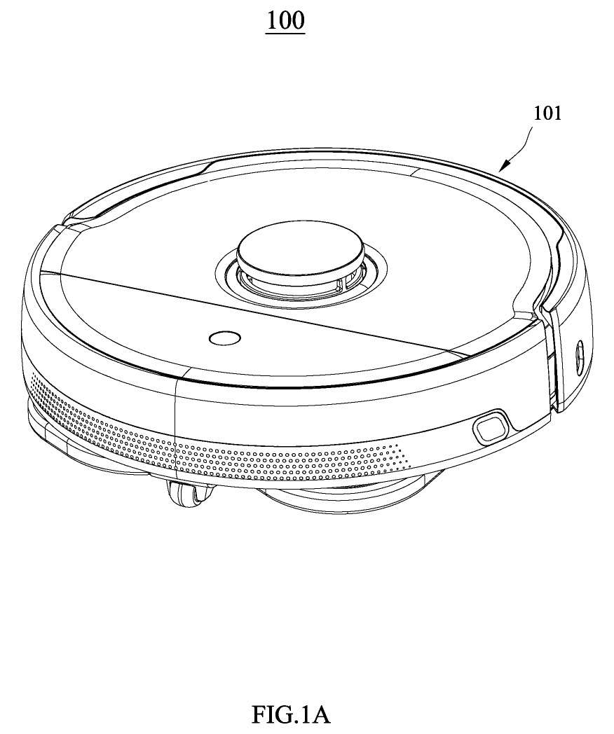

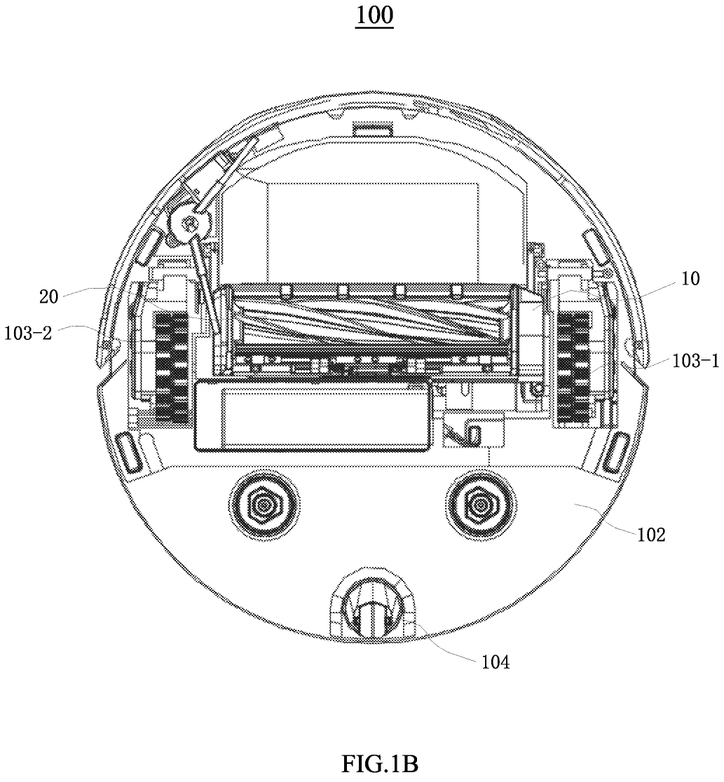

Embodiments of the present disclosure provide a roller brush assembly and a cleaning device. The cleaning device may be, for example, a handheld vacuum cleaner, a floor washer, a cleaning robot, a mopping robot, and a robot capable of at least one of mopping, cleaning, and washing. In the present implementation, referring to FIGS. 1A and 1B, a cleaning device 100 is taken as an example to illustrate the structure of the cantilever roller brush assembly provided in the present disclosure. It should be noted that the cantilever roller brush assembly may be used for any suitable vacuum cleaning device with a roller brush.

Cleaning device 100 can remove debris or dust from a surface by agitating, lifting, and collecting them from the surface by applying a negative pressure above the surface. The debris or dust described herein is not limited to solid waste, and may also include hair, thread, liquid, etc. In some implementations, cleaning device 100 includes a chassis 102 and a main body 101 connected to chassis 102. Main body 101 is supported by a driving system that can maneuver cleaning device 100 across a floor surface based on a command. The command may be input by a user directly on cleaning device 100 or through a remote control. The command may also be executed by the device itself through preinstalled or downloaded software instructions upon a triggering event, such as detection of a change of environment. The driving system may include a left driving wheel 103-1 and a right driving wheel 103-2 with respective driving motors, and a caster wheel 104 configured to further support cleaning device 100. Cleaning device 100 may further include a sensor system having one or more types of sensors. The sensors may function independently or collectively to create a perception of the environment surrounding cleaning device 100, so that the cleaning device 100 can make intelligent decisions about what actions to take in that environment. The sensor system may include one or more of the following: obstacle detection and avoidance sensor, communication sensor, navigation sensor, etc. Cleaning device 100 may include a navigation system configured to maneuver cleaning device 100. In one example, when cleaning device 100 detects obstruction by a wall or a piece of furniture by an obstacle detection and avoidance sensor, the sensor sends a signal to a processor that executes software instructions, and the navigation system is triggered to bypass the obstruction.

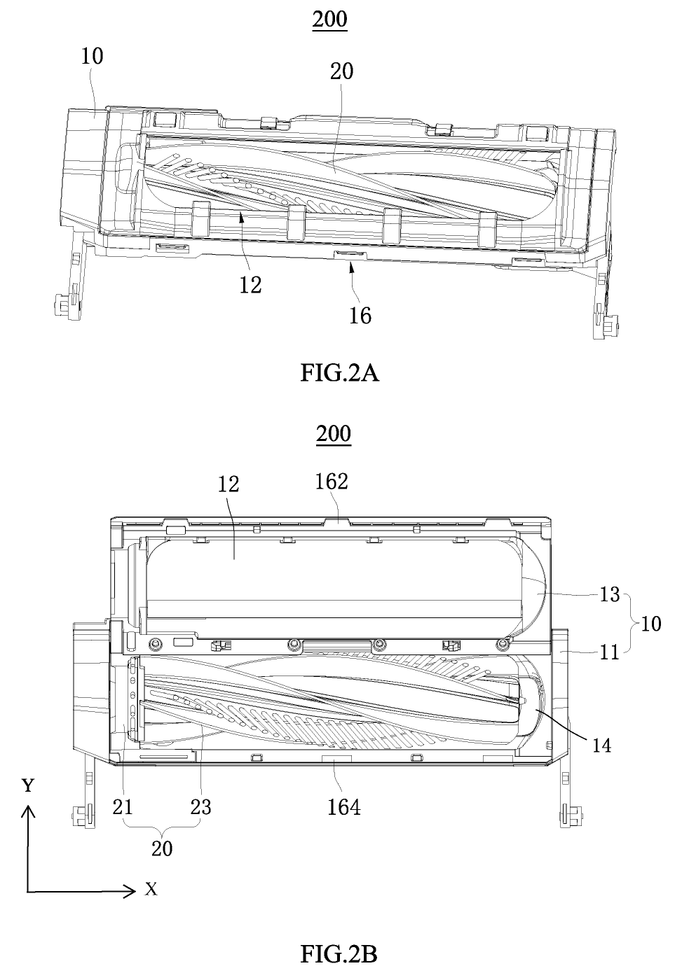

Cleaning device 100 may further include a cleaning system, such as a dry-cleaning system. The dry-cleaning system includes at least one roller brush assembly and at least one side brush assembly. The roller brush assembly is usually mounted within a suction chamber (e.g., suction chamber 10 shown in FIGS. 2A - 3) of cleaning device 100. The suction chamber is provided with an opening and an outlet by which dirt-bearing air can be drawn from outside cleaning device 100, through the suction chamber, and into other components of cleaning device 100. The dirt-bearing air is conveyed to a collector (not shown) of cleaning device 100 so that the dirt, debris, or dust can be separated from the air before the air is expelled out of cleaning device 100. The opening is in the form of an aperture, usually an elongated and rectangular aperture defined by a sole plate located on the bottom of main body 101 of cleaning device 100. The roller brush is exposed from the aperture and can be in contact with the surface to be cleaned through the opening. In some implementations, the outlet is provided between the two mounting ends of the roller brush with equal distance from each mounting end. In some other implementations, the location of the outlet is offset from the center between the two mounting ends of the roller brush when, for example, the roller brush is a cantilever roller brush.

According to the present disclosure, the roller brush of each roller brush assembly may be driven by an electric motor powered by a power supply of the cleaning device 100. The electric motor may cause the roller brush to rotate at a predetermined speed when cleaning device 100 moves on top of a surface that is to be cleaned. Therefore, cleaning device 100 can sweep the debris or dust scattered on the surface into its collector as it moves along. In occasions where the surface to be cleaned has a large friction coefficient, the cleaning process may consume a significant amount of energy. For example, when cleaning a carpet, the fibers of the carpet are agitated at the same time and thus the rotation of the roller brush and the movement of cleaning device 100 are slowed down.

During the cleaning process, in some implementations, bristles of the roller brush move from the front edge of the opening towards the rear edge and sweep the debris or dust rearwardly through the opening and into the suction chamber. The vacuum function of cleaning device 100 causes air to flow underneath the sole plate and around the roller brush, so that the debris or dust is lifted from the surface and then carried from the suction chamber to the collector via the outlet. When the debris or dust passes through the outlet, long strands of the debris (for example, hair, thread, or the like) may become wrapped around the roller brush or accumulated at or near the outlet, especially at the mounting ends of the roller brush. The reason is that the air passing through the suction chamber applies only a relatively minor force to those long strands of the debris, making them less likely to be blown or dragged into the collector, even if the roller brush rotates at a speed capable of sucking in the solid waste. The wrapped hair or thread may lead to an increased torque on the roller brush and slowdown of its rotation speed, and the accumulated hair or thread may partially block the outlet or be ejected out of the suction chamber by turbulent air, resulting in reduced cleaning efficiency and increased power consumption of cleaning device 100.

The cantilever roller brush may solve the above issues effectively by reducing the mounting ends of the roller brush from two to one and moving the outlet to an end of the suction chamber opposite to the mounting end. Less debris will be wrapped around the roller brush as the number of mounting ends is halved. As the outlet is positioned at an end of the suction chamber, the air pass is formed between the mounting end to the outlet, and the length of the air pass is almost equal to the length of the roller brush. Thus, debris and dust in the suction chamber can be guided to the outlet easily. However, stability of the cantilever roller brush is relatively low since it only has one mounting end.

The present disclosure provides a different, novel structure to couple the cantilever roller brush with cleaning device 100 in order to maintain its advantages while eliminating its disadvantages. In some implementations, a mounting bracket is configured to connect the cantilever roller brush with cleaning device 100, as opposed to the direct connection between the cantilever roller brush and the cleaning device. The mounting bracket is connected to the suction chamber by at least one pair of action force and reaction force applied on the mounting bracket and the suction chamber, so that the mounting bracket is fixed to the cleaning device while the cantilever roller brush is able to rotate in a cleaning process. The stability of the cantilever roller brush may be greatly improved by this tailor-made structure of the mounting bracket. Further, the cantilever roller brush according to the present disclosure can be handily taken out of the suction chamber in a direction towards the opening of the suction chamber, thus making its replacement and inspection much easier than existing products. Details of the mounting bracket and its connection with the suction chamber of cleaning device 100 will be described in more detail below.

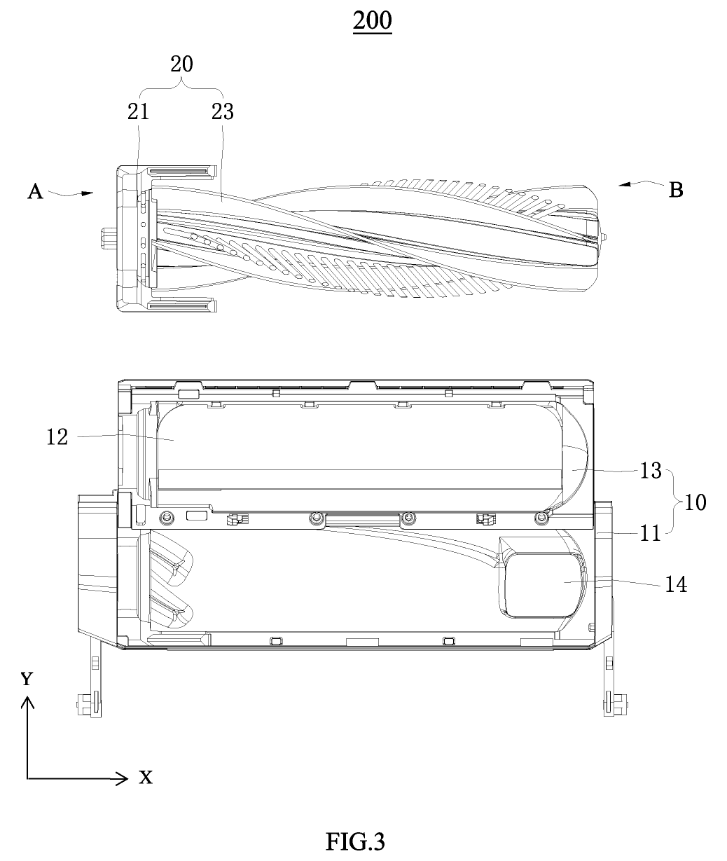

In some implementations, referring to FIGS. 1B, 2A, and 7, cleaning device 100 includes a suction chamber 10 disposed at a bottom of main body 101 and a roller brush assembly 20 mounted within suction chamber 10. Suction chamber 10 and roller brush assembly 20 are collectively referred to as a cleaning assembly 200, as shown in FIGS. 2A to 3. In some implementations, at least a portion of cleaning assembly 200 can be removed from cleaning device 100 from its bottom side. For example, roller brush assembly 20 can be taken out of cleaning assembly 200, as shown in FIG. 3, and thus removed from cleaning device 100. In another example, the cap (e.g., cap 13 in FIG. 2B) can be detached from the rest of suction chamber 10. This makes it easy to replace or inspect the components of cleaning assembly 200. Suction chamber 10 is provided with an opening 12 through which debris and dust can be picked up and guided to a collector of cleaning device 100 via an outlet 14. At least part of roller brush assembly 20 is exposed through opening 12 and in close proximity to or in contact with the surface to collect the debris and dust from the surface.

In some implementations, as shown in FIGS. 2B and 3, suction chamber 10 includes a basement 11 connected to cleaning device 100 and a cap 13 connected to basement 11. Cap 13 is provided with opening 12 positioned closely towards the surface to be cleaned during a cleaning process so that the debris and dust may be swept into suction chamber 10 through opening 12. The shape of opening 12 may be configured to match a portion of roller brush assembly 20 that faces the surface to be cleaned, so that a portion of roller brush assembly 20 may protrude downward beyond cap 13. By this configuration, the bristles of the roller brush may get closer to the surface than cap 13 or even touch the surface, allowing cleaning device 100 to meander above the debris and dust and sweep them into suction chamber 10, without them being obstructed by cap 13. Basement 11 is provided with outlet 14 connected to the collector of cleaning device 100 so that the debris and dust swept into suction chamber 10 can be guided into the collector of cleaning device 100 through outlet 14. Cap 13 is detachably connected with basement 11. In some embodiments, cap 13 can be directly detached from basement 11. In some embodiments, cap 13 can rotate between a close state (as shown in FIG. 2A) and an opening state (as shown in FIG. 2B and 3) with respect to basement 11. Roller brush assembly 20 can be fixedly connected with suction chamber 10 when cap 13 is in the close state. Roller brush assembly 20 can be removed from suction chamber 10 when cap 13 is in the opening state.

In some implementations, referring to FIGS. 2B-4, roller brush assembly 20 includes a mounting bracket 21 and a roller brush 23. In the present disclosure, roller brush 23 is a cantilever roller brush with a fixing end A connected with mounting bracket 21 and a free end B extending from fixing end A along the first direction, i.e., the length direction of roller brush 23 corresponding to the X-axis depicted in FIGS. 2B-4. It is noted that X and Y axes are included in FIGS. 2B-5 to further illustrate the spatial relationship of the components described herein. X and Y axes are perpendicular to each other and together form a lateral plane which, in some implementations, is parallel to the surface to be cleaned by cleaning device 100. Free end B of roller brush 23 is positioned closer to outlet 14 of suction chamber 10 than fixing end A, as shown in FIG. 3. Mounting bracket 21 is detachably fixed to suction chamber 10, and roller brush 23 is rotatably fixed to mounting bracket 21 through at least one bearing. With this configuration, roller brush assembly 20 can be attached to cleaning device 100 by mounting bracket 21. When roller brush 23 rotates during operation of cleaning device 100, the position of mounting bracket 21 relative to that of cleaning device 100 remains unchanged, thus stabilizing the rotation of roller brush 23. The stabilized rotation also reduces jittering of roller brush 23, thus eliminating unpleasant noises caused by the contact between roller brush 23 and the surface during a cleaning process.

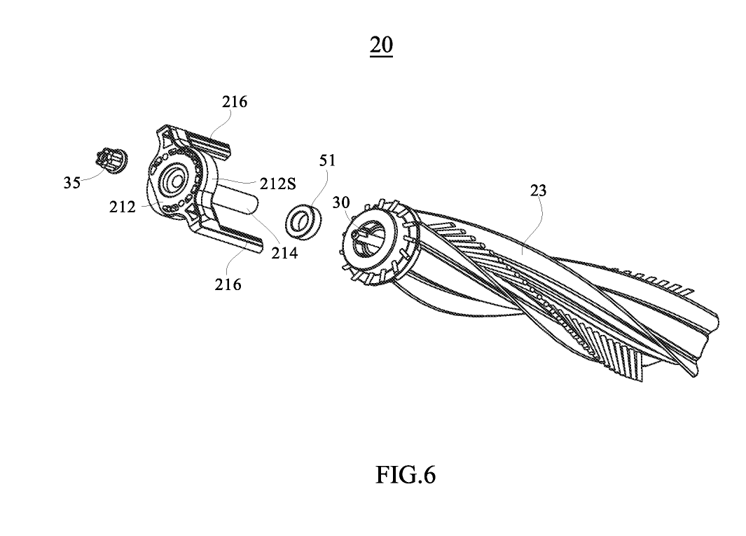

In some implementations, roller brush 23 is rotatably connected with mounting bracket 21 through a rotatable core 40, as shown in FIG. 5. Rotate coupling, as used herein, indicates that one component is able to rotate relatively to the other when they are connected together. FIG. 5 illustrates a first exploded view of roller brush assembly 20, according to some aspects of the present disclosure. Rotatable core 40 includes a first end non-rotatably connected with roller brush 23, and a second end rotatably connected with mounting bracket 21. When rotatable core 40 is caused to rotate, it brings roller brush 23 to rotate along while the position of mounting bracket 21 remains unchanged relatively to suction chamber 10. Roller brush 23 includes a connecting slot 30 at fixing end A to accommodate the first end of rotatable core 40, as shown in FIGS. 5 and 6. The first end of rotatable core 40 may be detachably fixed with roller brush 23 or integrally molded with roller brush 23. The detachable fixing may include snap-fit connection, screw, pin, clip, fastener, or the like. The second end of rotatable core 40 may be detachably fixed with mounting bracket 21. The detachable fixing may include snap-fit connection, screw, pin, clip, fastener, or the like. In some implementations, either the first end of rotatable core 40 is detachably fixed with mounting bracket 21, or the second end of rotatable core 40 is detachably fixed with roller brush 23, or both, so that roller brush 23 may be released from mounting bracket 21 to make it easy to replace roller brush 23.

In some implementations, connecting slot 30 extends along the length direction of roller brush 23 corresponding to the X-axis depicted in FIG. 5. In some other implementations, connecting slot 30 extends along the direction deviating from the length direction of roller brush 23. Connecting slot 30 can be a well-like cylindrical cavity inside roller brush 23 with an opening at or near one end of roller brush 23, such as fixing end A. In some implementations, the first end of rotatable core 40 is positioned within connecting slot 30 and extends along the extending direction of connecting slot 30. The second end of rotatable core 40 extends beyond fixing end A of roller brush 23. Once assembled, rotatable core 40 can be viewed as being inserted into connecting slot 30 with a portion of rotatable core 40 protruding out of the opening, as shown in FIG. 6.

In some implementations, roller brush 23 is provided with a plurality of bristles or strips to remove debris and dust from the surface during rotation. In some implementations, in order to keep roller brush 23 stable during rotation, rotatable core 40 and mounting bracket 21 may be made of rigid or stiff materials, such as metal, alloy, or the like. In some other implementations, rotatable core 40 and mounting bracket 21 may be made of lighter materials, such as polymer (e.g., plastic), or carbon fiber, in order to reduce total weight of roller brush assembly 20 and decrease inertia of roller brush assembly 20. The smaller the inertia of roller brush assembly 20, the less likely roller brush 23 breaks apart from cleaning device 100 due to excessive inertia during rotation. In some other implementations, rotatable core 40 and mounting bracket 21 may be made of a combination of materials. For example, mounting bracket 21 is made of metal and rotatable core 40 is made of plastic, or rotatable core 40 is made of metal and mounting bracket 21 is made of plastic. In some implementations, a mounting base 212 of mounting bracket 21 is made of carbon fiber to reduce weight while a connector 214 of mounting bracket is made of metal to achieve a stable support.

In some implementations, rotatable core 40 is detachably connected with the driving unit of cleaning device 100, and an additional force is necessary in most occasions to detach rotatable core 40 from the driving unit. Therefore, rotatable core 40 may be made of one or more of metal, carbon fiber, high UTS (ultimate tensile strength) polymer materials (such as polycarbonate, polystyrene, polyoxymethylene, etc.), or other suitable materials with enough strength to prevent rotatable core 40 from being damaged or deformed during detachment. In some implementations, rotatable core 40 is integrally molded with roller brush 23.

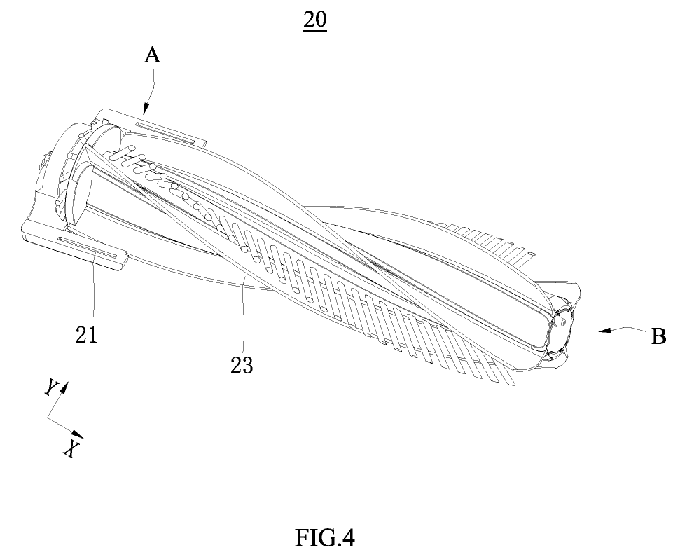

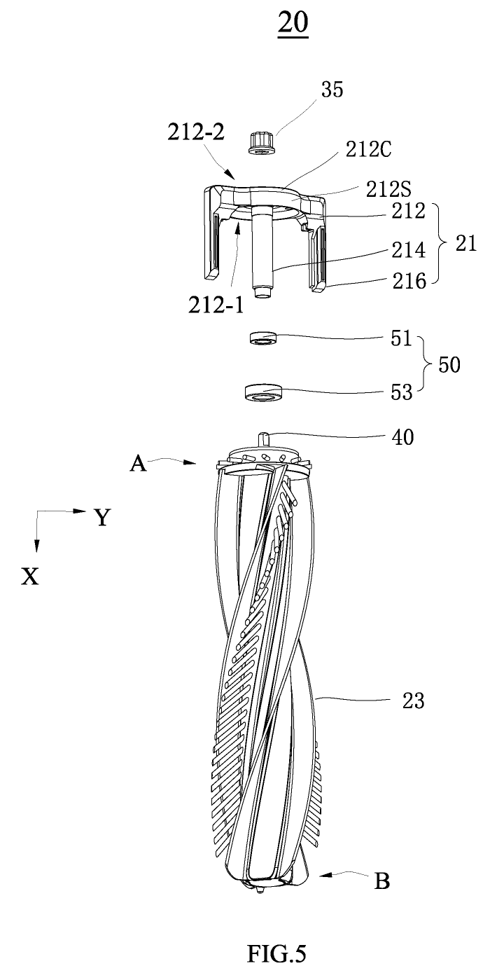

Referring to FIGS. 4 - 6, mounting bracket 21 may include mounting base 212 and connector 214. Mounting base 212 is configured to fix mounting bracket 21 to cleaning device 100, and connector 214 extends from a center of mounting base 212 along the length direction of roller brush 23 and is accommodated by connecting slot 30. In some implementations, the center of mounting base 212 may be one of the following: geometric center, gravity center, or a center of a plane defined by a side of mounting base 212. In some implementations, connector 214 is a hollow cylinder so that second end 40-2 of rotatable core 40 can be positioned within the hollow cylinder. Rotatable core 40 can be viewed as being inserted into connector 214. In some implementations, connector 214 is accommodated by connecting slot 30 of roller brush 23. Mounting bracket 21 may further include at least one supporting arm 216.

Referring to FIG. 5, mounting base 212 includes a first side 212-1 and a second side 212-2 opposite to first side 212-1. A side surface 212S is positioned between and perpendicular to first side 212-1 and second side 212-2. First side 212-1 is connected with roller brush 23. In some implementations, side surface 212S of mounting base 212 is not required to contact cleaning device 100 in order for mounting base 212 to couple with cleaning device 100. In some implementations, rotatable core 40 passes through connector 214 and mounting base 212 and extends through second side 212-2 of mounting base 212. In some implementations, first side 212-1 of mounting base 212 is pressed against fixing end A of roller brush 23 to reduce space required for assembly. In some other implementations, a gap exists between first side 212-1 of mounting base 212 and fixing end A of roller brush 23 to minimize friction between mounting base 212 and roller brush 23 during a cleaning process.

In some implementations, referring to FIG. 5, connector 214 is positioned at the geometric center of mounting base 212 and extends away from first side 212-1 of mounting base 212 towards roller brush 23. As shown in FIG. 5, connector 214 extends into connecting slot 30 and accommodates rotatable core 40 at the same time. Rotatable core 40 passes through connector 214 and mounting base 212 so that the second end of rotatable core 40 may extend beyond second side 212-2 of mounting base 212 and connect with a connecting cap 35. Connecting cap 35 and the second end of rotatable core 40 may be directly connected by snap-fit connection, screw, pin, clip, fastener, or the like. Mounting base 212 is sandwiched between connecting cap 35 and roller brush 23. In some implementations, connector 214 is non-removably attached to first side 212-1 of mounting base 212 in a manner including gluing, riveting, welding, or the like. In some implementations, connector 214 and mounting base 212 are separately molded and thus detachable from each other. For example, connector 214 is removably mounted to first side 212-1 of mounting base 212 in a manner including snap-fit connection, screw, pin, clip, fastener, or the like. In some implementations, an end of connector 214 connected with mounting base 212 extends into mounting base 212. In some other implementations, the end of connector 214 connected with mounting base 212 stops at and thus positioned outside of first side 212-1 of mounting base 212.

In some implementations, connecting cap 35 is positioned at second side 212-2 of mounting base 212. Connecting cap 35 is fixedly connected with rotatable core 40 (for example, by direct connection between connecting cap 35 and the second end of rotatable core 40, as described above), and rotatable core 40 is able to rotate along with connecting cap 35. Connecting cap 35 may be connected between rotatable core 40 and the driving unit to enhance dynamic linkage between them, so that the driving unit may more efficiently drive the rotation of rotatable core 40. Connecting cap 35 may also be able to eliminate wear and tear of rotatable core 40 as a result of direct connection between rotatable core 40 and the driving unit. In some implementations, connecting cap 35 is detachably connected with rotatable core 40 through snap-fit connection, screw, pin, clip, fastener, or the like. In this way, connecting cap 35 can be easily replaced when needed. In some implementations, connecting cap 35 is fixedly connected with rotatable core 40 through gluing, riveting, welding, or the like.

In some implementations where the second end of rotatable core 40 does not extend beyond mounting base 212, at least part of connecting cap 35 may extend into mounting base 212 to connect with rotatable core 40. A gap exists between connecting cap 35 and mounting base 212 to avoid wear and tear generated during the rotation of connecting cap 35. In some implementations, at least one bearing is positioned between connecting cap 35 and mounting base 212 so that mounting base 212 would not be rotated or displaced by the rotation of connecting cap 35.

In some implementations, connector 214 may be connected with roller brush 23 via a bearing assembly 50, as shown in FIGS. 5 and 6. Bearing assembly 50 includes a first bearing 51 connected with a first end of connector 214 adjacent to mounting base 212 and a second bearing 53 connected with a second end of connector 214 away from mounting base 212. During rotation of roller brush 23, mounting base 212 and connector 214 are stationary with respect to suction chamber 10. Bearing assembly 50 is able to separate connector 214 from connecting slot 30 of roller brush 23 and provide a gap between them to reduce friction. In some implementations, first bearing 51 and second bearing 53 are positioned at two ends of connector 214 respectively to keep connector 214 stable during operation. With the help of first bearing 51 and second bearing 53, despite having an extended length along the rotating axis of roller brush 23, connector 214 will not deviate from its position, e.g., bumping with connecting slot 30, when roller brush 23 rotates. As a result, the stability of roller brush assembly 20 is improved.

In some implementations, as shown in FIGS. 5 and 6, mounting bracket 21 further includes at least one supporting arm 216 extending from an edge of mounting base 212 along the length direction of roller brush 23. The at least one supporting arm 216 is configured to detachably fix mounting bracket 21 to suction chamber 10. In some implementations, a number of the at least one supporting arm 216 is two, and the two supporting arms 216 are symmetrically provided with respect to connector 214, as shown in FIG. 5. An end of each supporting arm 216 is integrally molded with mounting base 212 and the other end of each supporting arm 216 extends along the length direction of roller brush 23. The two supporting arms 216 may be parallel to each other. In some implementations, the lengths of the two supporting arms are equal. A coupling area between mounting bracket 21 and suction chamber 10 is increased with the configuration of the at least one supporting arm 216. Thus, the stability of mounting bracket 21 is enhanced. The length of each supporting arm 216 may not be too long, for example, longer than the length of roller brush 23, which increases the manufacturing cost, makes it difficult to mount roller brush 23 with mounting bracket 21, and may cause rupture of supporting arm 216 from mounting base 212. The length of each supporting arms 216 may not be too short, for example, one-tenth of the length of roller brush 23, which may not be able to provide sufficient support to stabilize roller brush 23 and prevent roller brush 23 from deviating from its rotating axis during rotation. In some implementations, a ratio between the length of supporting arm 216 and the length of roller brush 23 is between 1:1 to 1:10 (both inclusive), thus making it relatively easy to mount roller brush 23 with mounting bracket 21 while also keeping roller brush 23 stabilized during rotation. For example, the ratio can be 1:1, 1:2, 1:3, 1:4, 1:5, 1:6, 1:7, 1:8, 1:9, 1:10, or any value between two of the enumerated ratios. In the example illustrated in FIGS. 5 and 6, the length of supporting arm 216 is one-fifth of the length of roller brush 23.

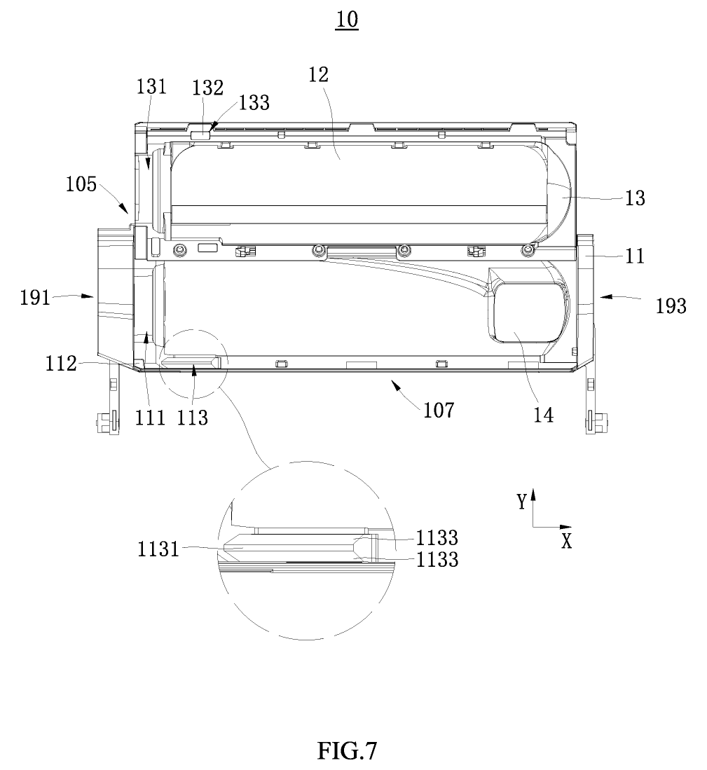

In some implementations, referring to FIGS. 3 and 7, mounting bracket 21 is fixed between basement 11 and cap 13 in suction chamber 10 by at least one pair of action force and reaction force applied to mounting bracket 21 and suction chamber 10. Referring to FIG. 7, suction chamber 10 includes a first end 191 through which roller brush 23 is connected to, and a second end 193 away from first end 191 along the X direction. Outlet 14 is positioned adjacent to second end 193.

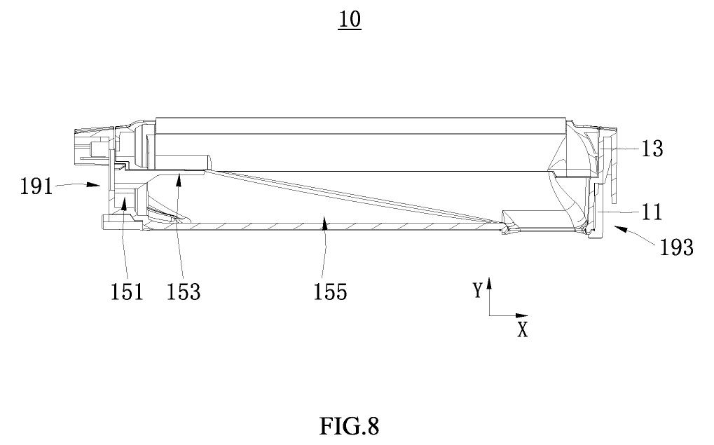

FIG. 8 illustrates a cross-sectional view of suction chamber 10, according to some aspects of the present disclosure. Suction chamber 10 includes a first cavity 151, a second cavity 153, and a third cavity 155. First cavity 151 is positioned at first end 191 of suction chamber 10 and is configured to accommodate mounting base 212. Second cavity 153 is positioned adjacent to first cavity 151 and is configured to accommodate supporting arm 216. In some implementations, first cavity 151 and second cavity 153 are connected to each other to accommodate mounting base 212 and supporting arm 216 as a whole. In some implementations, first cavity 151 and second cavity 153 are isolated from each other to accommodate mounting base 212 and supporting arm 216 respectively. As shown in FIGS. 7 and 8, first cavity 151 and second cavity 153 are formed inside the sidewall of basement 11 and the sidewall of cap 13. Third cavity 155 can be significantly larger than first cavity 151 and second cavity 153. Third cavity 155 can be defined by the sidewall of basement 11 and the sidewall of cap 13 and configured to accommodate roller brush 23. When roller brush assembly 20 is connected within suction chamber 10 and cap 13 is connected to basement 11, mounting base 212 is confined and fixed by first cavity 151, supporting arm 216 is confined and fixed by second cavity 153, and roller brush 23 is rotatably positioned within third cavity 155.

In some implementations, referring to FIG. 7, first cavity 151 can be formed by a first portion 111 of the sidewall of basement 11 and a first portion 131 of the sidewall of cap 13. Both side walls are positioned at or near first end 191 of suction chamber 10. Each of first portion 111 and first portion 131 can be a concave portion accommodating a part of mounting base 212 of mounting bracket 21. When cap 13 is in the close state, first portion 111 and first portion 131 form first cavity 151, which may have the same shape as mounting base 212, so that mounting base 212 can be fixed in first cavity 151 by a first pair of action-reaction forces applied between mounting base 212 and suction chamber 10. For example, the shape of mounting base 212 and first cavity 151 can include cylinder, ellipsoid, cube, polyhedral, or any combination of two or more aforementioned shapes. The first pair of action-reaction forces includes a first action force and a first reaction force. The first action force is generated by mounting base 212 and is applied to at least one of first portion 111 of basement 11 and first portion 131 of cap 13. The first reaction force is generated from at least one of first portion 111 of basement 11 and first portion 131 of cap 13 and is applied to mounting base 212. Mounting bracket 21 can be kept stationary during the rotation of roller brush 23 as mounting base 212 is stably fixed by first cavity 151.

In some implementations, referring to FIG. 7, second cavity 153 can be formed by a second portion 113 of the sidewall of basement 11 and a second portion 133 of the sidewall of cap 13. Second portion 113 of basement 11 is positioned adjacent to first portion 111 of basement 11, and second portion 133 of cap 13 is positioned adjacent to first portion 131 of cap 13. In some implementations, each of second portion 113 and second portion 133 is a concave portion accommodating a part of supporting arm 216 of mounting bracket 21. When cap 13 is in the close state, second portion 113 and second portion 133 form second cavity 153, which may have the same shape as supporting arm 216, so that supporting arm 216 can be fixed in second cavity 153 by a second pair of action-reaction forces. For example, second portion 113 of basement 11 may be a slot having the same shape as a first side of supporting arm 216, as shown in FIG. 7. Second portion 113 includes a bottom surface 1131 positioned at the bottom of the slot and two side surfaces extending from bottom surface 1131 towards the top of the slot. For example, second portion 133 of cap 13 may be a recess having the same shape as a second side of supporting arm 216, as shown in FIG. 7. Second portion 133 is as flat as the second side of supporting arm 216. The second pair of action-reaction forces include a second action force and a second reaction force. The second action force is generated from supporting arm 216 and is applied to at least one of second portion 113 of basement 11 and second portion 133 of cap 13. The second reaction force is generated from at least one of second portion 113 of basement 11 and second portion 133 of cap 13 and is applied to supporting arm 216. Mounting bracket 21 can be further stabilized during the rotation of roller brush 23 as supporting arm 216 is stably fixed by second cavity 153.

In some implementations, the first pair of action-reaction and the second pair of action-reaction forces are generated as a result of cap 13 being connected with basement 11 and supporting arm 216 being detachably fixed between basement 11 and cap 13. Referring to FIGS. 2A and 2B, basement 11 is connected with cap 13 by a connector assembly 16. In some implementations, connector assembly 16 includes a snap-fit member 162 provided on cap 13 and a corresponding mating member 164 provided on basement 11. In some implementations, snap-fit member 162 can be provided on basement 11 and corresponding mating member 164 can be provided on cap 13. The relative position and the number of connector assembly 16 can be designed as needed and should not be limited to the implementations above. In some implementations, a plurality of connector assemblies 16 are provided on both a first side 105 and a second side 107 of suction chamber 10. In some implementations, a plurality of connector assemblies 16 are provided only on one side of suction chamber 10 while the other side of suction chamber 10 are connected through other connectors, such as springs, bearings, magnets, or the like. In some implementations, snap-fit member 162 may be a tongue piece laterally extending from a surface of cap 13 to be connected with basement 11, and mating member 164 can be an opening provided on basement 11 corresponding to snap-fit member 162. When cap 13 is connected with basement 11, the tongue piece is accommodated and locked by the opening so that cap 13 does not come off from basement 11. In some implementations, snap-fit member 162 and corresponding mating member 164 may have other structures that can fix basement 11 and cap 13, and the detailed structure of connector assembly 16 should not be limited to the implementations above.

In some implementations, referring to FIG. 7, suction chamber 10 further includes at least one flexible protrusion 132, which may be disposed between supporting arm 216 and suction chamber 10 when basement 11 is connected with cap 13. In some implementations, flexible protrusion 132 can be provided on any one of second portion 113 of basement 11, second portion 133 of cap 13, or supporting arm 216, so that flexible protrusion 132 can be positioned between supporting arm 216 and second portion 133 of cap 13 or between supporting arm 216 and second portion 113 of basement 11. In some implementations, two or more flexible protrusions 132 are provided on both sides of supporting arm 216. Flexible protrusion 132 can include silicone, rubber, polyimide, polyester, or other flexible materials. When cap 13 is fixedly connected with basement 11, flexible protrusion 132 deforms under a pressure generated from the second pair of action-reaction forces between supporting arm 216 and suction chamber 10. The second pair of action-reaction forces are enforced by pressure generated by the deformation of flexible protrusion 132, and therefore the stability of supporting arm 216 within second cavity 153 can be further improved.

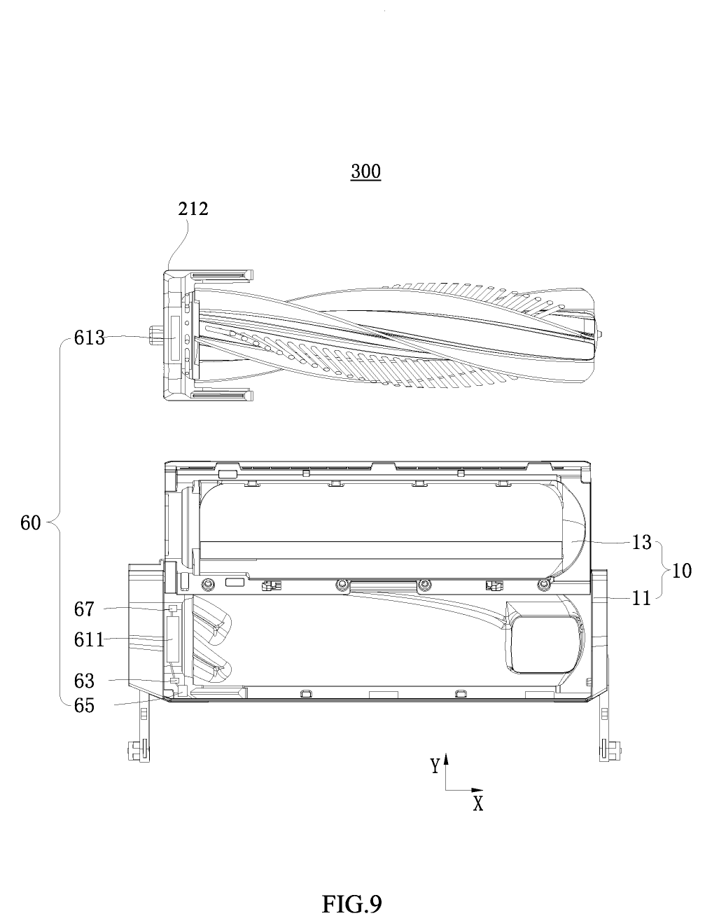

In some implementations, the first pair of action-reaction forces and the second pair of action-reaction forces are generated in response to supporting arm 216 being detachably fixed with basement 11 by at least one fastener assembly, whether cap 13 is connected with basement 11 or not. The at least one fastener assembly may include a magnet assembly 60, as shown in FIG. 9. FIG. 9 illustrates a structure of a cleaning assembly 300 with magnet assembly 60, according to some aspects of the present disclosure. Magnet assembly 60 may include a first magnet 611 provided on basement 11 and a second magnet 613 provided on mounting base 212 correspondingly. In some implementations, one of first magnet 611 and second magnet 613 includes a magnetic material, such as permanent magnet, electromagnet, or the like, while the other includes a non-magnetic material that can be attracted by magnetic material, such as iron, nickel, cobalt, their alloys, or the like. In some implementations, both first magnet 611 and second magnet 613 include a magnetic material. In some implementations, when one of first magnet 611 and second magnet 613 includes a magnetic material, the other can be omitted when the corresponding mounting base 212 or basement 11 is made of iron, nickel, cobalt, their alloys, or the like, and thus capable of attracting the magnet.

In some implementations, when mounting base 212 is positioned in first cavity 151, first magnet 611 and second magnet 613 are attracted to each other. The magnetic force between first magnet 611 and second magnet 613 holds mounting base 212 together with basement 11. The stronger the magnetic force is, the more stable the connection between mounting base 212 and basement 11 is. Mounting base 212 can be separated from basement 11 when a force opposite to and larger than the magnetic force is applied to mounting base 212. By adjusting the material and size of one or both of first magnet 611 and second magnet 613, the magnetic force between them can be adjusted as needed.

In some implementations, at least one of first magnet 611 and second magnet 613 is an electromagnet. Referring to FIG. 9, for example, first magnet 611 is an electromagnet, and magnet assembly 60 further includes a control circuit 63, a switch 65, and a detector 67. Control circuit 63 is connected with first magnet 611 and configured to adjust the magnetic force between first magnet 611 and second magnet 613 by controlling a current flowing through first magnet 611. Detector 67 is configured to detect a distance between first magnet 611 and second magnet 613. Switch 65 is configured to automatically turn on control circuit 63 in response to the distance being smaller than a threshold distance. For example, the threshold distance between first magnet 611 and second magnet 613 is 1 cm. When the distance between first magnet 611 and second magnet 613 is less than or equal to 1cm, detector 67 generates a signal indicating that switch 65 should be turned on, thus enabling control circuit 63 to generate the magnetic force between first magnet 611 and second magnet 613. As a result, mounting base 212 can be fixedly connected to basement 11. When the distance between first magnet 611 and second magnet 613 is larger than 1cm, detector 67 generates a signal indicating that switch should be turned off, thus disabling control circuit 63 and eliminating the magnetic force between first magnet 611 and second magnet 613. As a result, mounting base 212 can be detached from basement 11.

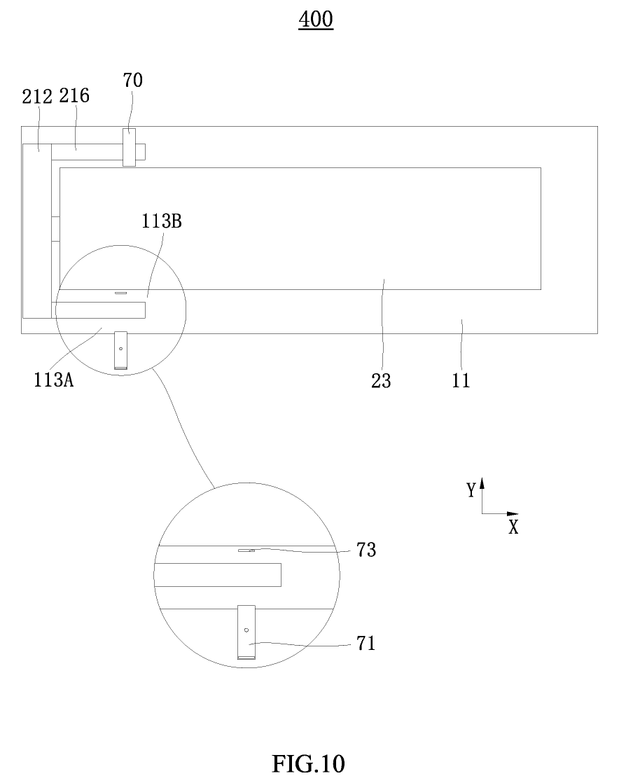

In some implementations, the at least one fastener assembly includes a rotatable fastener assembly 70, as shown in FIG. 10. FIG. 10 illustrates a schematic block diagram of a cleaning assembly 400 with rotatable fastener assembly 70, according to some aspects of the present disclosure. FIG. 10 is a simplified version of a schematic block diagram configured to illustrate the structure of the fastener assembly, and the details of cleaning assembly 400 are omitted for brevity. It should be understood that, other than rotatable fastener assembly 70, cleaning assembly 400 may have the same or similar structure as cleaning assembly 200. The size and shape of the components of rotatable fastener assembly 70 in FIG. 10 are illustrative and should not be limited to the implementations described herein, and any suitable structure can be applied to the present implementations with the teaching of the present disclosure.

Referring to FIG. 10, rotatable fastener assembly 70 may include a first fastener 71 rotatably provided on basement 11 and adjacent to a first side 113A of second portion 113 of basement 11 and a corresponding mating member 73 provided on basement 11 adjacent to a second side 113B of second portion 113 of basement 11. In some implementations, the positions of first fastener 71 and mating member 73 can be switched. It should be understood that the positions of first fastener 71 and mating member 73 relative to the other components of the suction chamber can be changed and should not be limited to the implementations above.

As shown in FIG. 10, first fastener 71 is rotatably fixed relative to basement 11 and can be freely rotated to get close to or away from mating member 73. First fastener 71 can be made of a rigid or stiff material, such as metal, alloy, or the like. When first fastener 71 is connected with mating member 73, the relative positions between first fastener 71 and basement 11 are fixed, and thus corresponding supporting arm 216 is locked in second cavity 153 by first fastener 71. Therefore, mounting bracket 21 can be fixed to basement 11 without cap13 being connected to basement 11. When first fastener 71 is released from mating member 73, supporting arm 216 can be taken out from second cavity 153. In some implementations, more than one rotatable fastener assembly 70 is provided for each supporting arm 216, and the number of rotatable fastener assemblies 70 is more than or equal to the number of supporting arms 216.

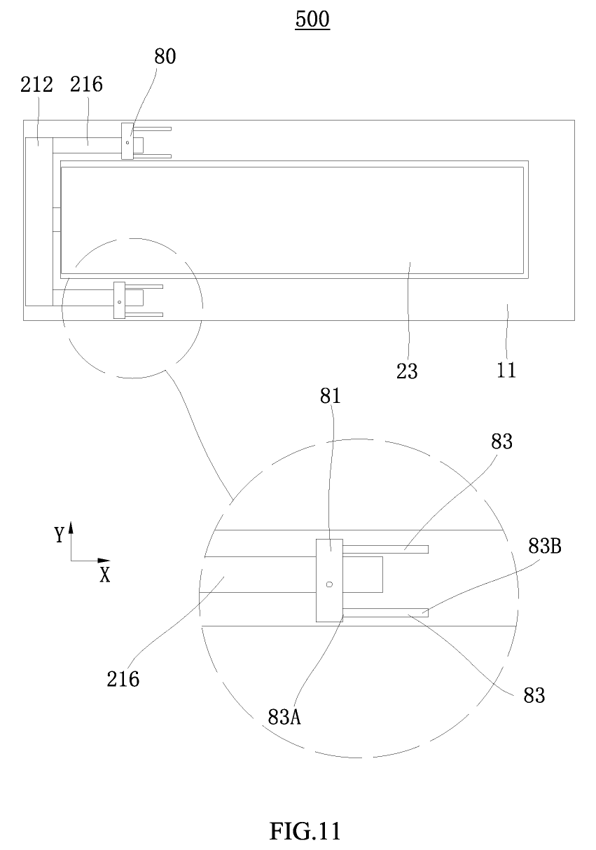

In some implementations, the at least one fastener assembly includes a slotted fastener assembly 80, as shown in FIG. 11. FIG. 11 illustrates a schematic block diagram of a cleaning assembly 500 with slotted fastener assembly 80, according to some aspects of the present disclosure. FIG. 11 is also a simplified version of a schematic block diagram configured to illustrate the structure of the fastener assembly, and the details of cleaning assembly 500 are omitted for brevity. It should be understood that, other than slotted fastener assembly 80, cleaning assembly 500 may have the same or similar structure as cleaning assembly 200. The size and shape of the components of slotted fastener assembly 80 in FIG. 11 are illustrative and should not be limited to the implementations described herein, and any suitable structure can be applied to the present implementations with the teaching of the present disclosure.

Referring to FIG. 11, slotted fastener assembly 80 may include a pair of slots 83 provided on basement 11 and a second fastener 81 configured to slide into the pair of slots 83. Slots 83 extend parallelly to supporting arm 216, and supporting arm 216 is positioned between the pair of slots 83. As shown in FIG. 11, two slots 83 have the same length, and a free end of supporting arm 216 away from mounting base 212 extends beyond a first end 83A of slot 83 but short of a second end 83B of slot 83. Second fastener 81 is provided with two connectors connected with each slot 83 respectively, and thus second fastener 81 can slide along slots 83 and stop at any position between first end 83A and second end 83B.

As shown in FIG. 11, second fastener 81 can be made of a rigid or stiff material, such as metal, alloy, or the like. When second fastener 81 is positioned at first end 83A of slot 83, second fastener 81 is pressed against corresponding supporting arm 216 to fix supporting arm 216 in second cavity 153, and thereby mounting bracket 21 can be fixed to basement 11 without cap 13 being connected to basement 11. When second fastener 81 is positioned at second end 83B of slot 83, second fastener 81 is away from corresponding supporting arm 216, and supporting arm 216 can be detached from second cavity 153.

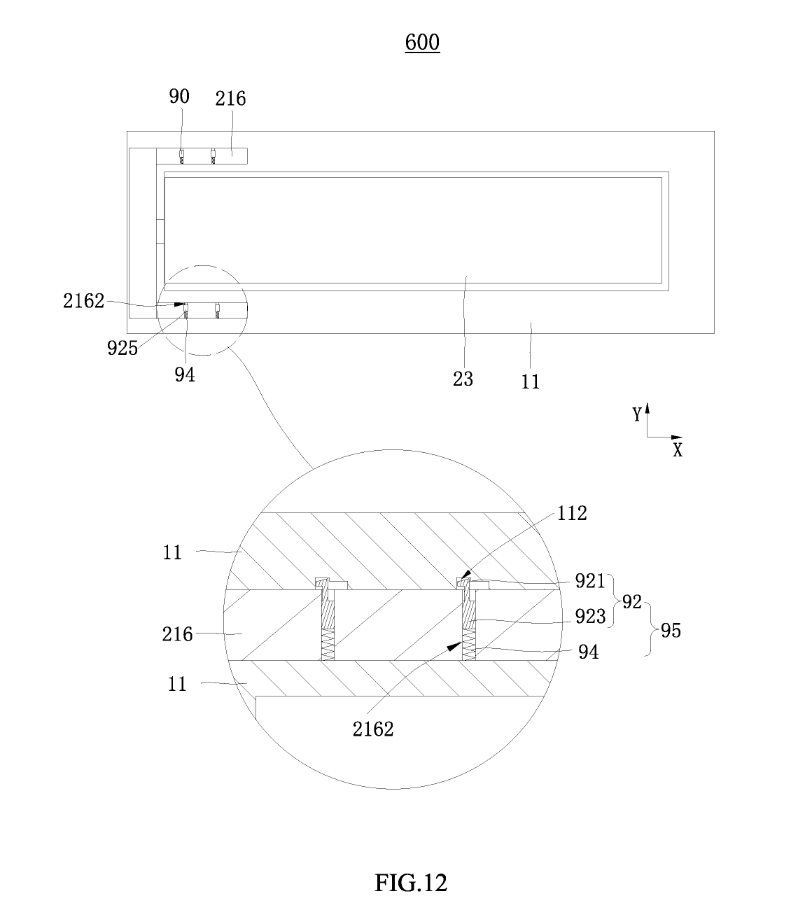

In some implementations, the at least one fastener assembly includes a spring fastener assembly 90, as shown in FIG. 12. FIG. 12 illustrates a schematic block diagram of cleaning assembly 600 with spring fastener assembly 90, according to some aspects of the present disclosure. FIG. 12 is also a simplified version of schematic block diagram configured to illustrate the structure of the fastener assembly, and the details of cleaning assembly 600 are omitted for brevity. It should be understood that, other than spring fastener assembly 90, cleaning assembly 600 may have the same or similar structure as cleaning assembly 200. The size and shape of the components of spring fastener assembly 90 in FIG. 12 are illustrative and should not be limited to the implementations described herein, and any suitable structure can be applied to the present implementations with the teaching of the present disclosure.

Referring to FIG. 12, spring fastener assembly 90 may include a third fastener 95 positioned on supporting arm 216 and a mating member 112 positioned on basement 11. In some implementations, as shown in FIG. 12, third fastener 95 may be positioned in a slot 2162 in supporting arm 216. Slot 2162 extends along the Y direction and penetrates supporting arm 216, so that third fastener 95 can extend beyond slot 2162. Mating member 112 may be a slot provided on basement 11 corresponding to third fastener 95. Mating member 112 may include a locking portion configured to fix third fastener 95 with basement 11 and an opening connected to the locking portion so that third fastener 95 can get into and out of the locking portion.

Referring to FIG. 12, third fastener 95 includes a rigid portion 92 and a spring 94 connected with rigid portion 92. With the deformation of spring 94, a length of third fastener 95 changes. For example, rigid portion 92 is retracted into slot 2162 of supporting arm 216 in response to spring 94 being compressed, and rigid portion 92 extends out of slot 2162 of supporting arm 216 and is fixedly connected with mating member 112 on basement 11 in response to spring 94 being released. In some implementations, rigid portion 92 includes a coupling portion 921 provided at the top of rigid portion 92, a connecting portion 923 configured to connect coupling portion 921 with spring 94, and a sliding portion 925 positioned out of slot 2162.

In some implementations, coupling portion 921 and connecting portion 923 can be made of a rigid or stiff material, such as metal, alloy, or the like. Materials of coupling portion 921 and connecting portion 923 can be different or the same. Referring to FIG. 12, both coupling portion 921 and connecting portion 923 extend along the Y direction, i.e., the same direction as the extending direction of slot 2162. A diameter of connecting portion 923 is slightly less than a diameter of slot 2162, so that third fastener 95 can slide into slot 2162 stably and smoothly. In some implementations, coupling portion 921 has a hook-shaped end, and a diameter of coupling portion 921 is smaller than a diameter of connecting portion 923. For example, the diameter of coupling portion 921 is half of the diameter of connecting portion 923, and coupling portion 921 is positioned at one side of slot 2162 adjacent to the hook-shaped end, as shown in FIG. 12. In some implementations, although made of a rigid material, coupling portion 921 can be slightly deformed to a certain extent and then return to the original shape.

In the present implementations, when spring 94 is compressed, both coupling portion 921 and connecting portion 923 are positioned in slot 2162, with coupling portion 921 in a deformed state, and mounting bracket 21 can be detached from basement 11. When spring 94 is released from compression, coupling portion 921 extends out of slot 2162. The hook-shaped end of coupling portion 921 extends into the opening of mating member 112 and then fits with the locking portion of mating member 112. Therefore, supporting arm 216 is fixedly connected with basement 11, and mounting bracket 21 can be fixed to basement 11 without cap 13 being connected to basement 11. Sliding portion 925 is connected with connecting portion 923 and positioned out of slot 2162. A width of sliding portion 925 is slightly larger than slot 2162 so that sliding portion 925 can slide on slot 2162 stably. By changing the position of sliding portion 925, the state of spring 94 can be changed from a compressed state to a released state, and vice versa.

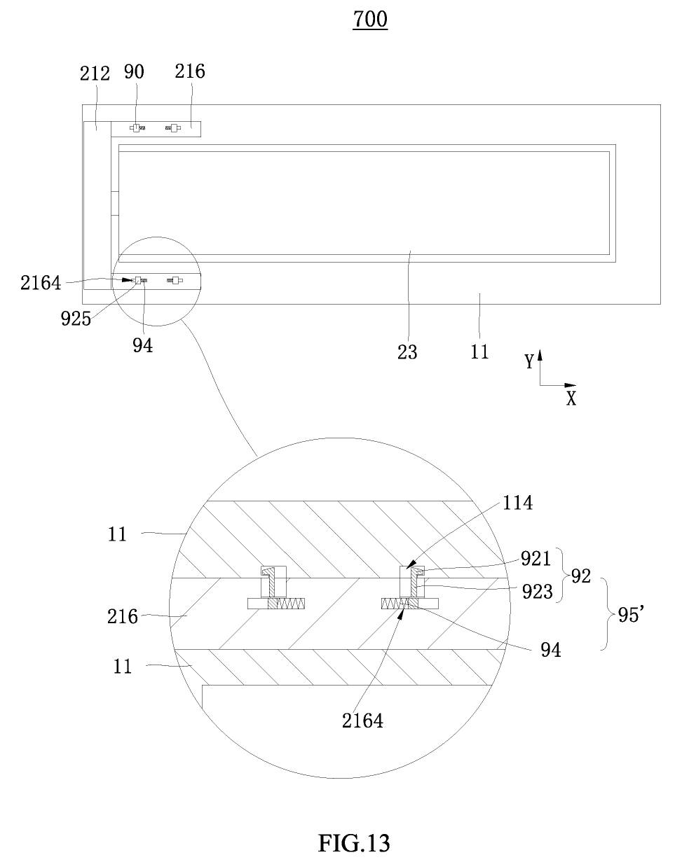

FIG. 13 illustrates a schematic block diagram of a cleaning assembly 700 with another spring fastener assembly 90, according to some aspects of the present disclosure. Referring to FIG. 13, same as spring fastener assembly 90 in cleaning assembly 600, spring fastener assembly 90 in cleaning assembly 700 also includes a third fastener 95’ positioned in a slot 2164 in supporting arm 216 and a mating member 114 positioned on basement 11. What distinguishes cleaning assembly 700 from cleaning assembly 600 is that slot 2164 extends along the X direction with an opening corresponding to mating member 114 on basement 11.

Similar to third fastener 95, third fastener 95’ also includes a rigid portion 92 and a spring 94 connected with rigid portion 92. Rigid portion 92 further includes a coupling portion 921, a connecting portion 923, and a sliding portion 925. As shown in FIG. 13, coupling portion 921 is perpendicular to connecting portion 923. When spring 94 is compressed, coupling portion 921 is positioned in the opening of mating member 114, supporting arm 216 can be detached from basement 11. When spring 94 is released from compression, coupling portion 921 moves forward and the hook-shaped end of coupling portion 921 extends into the locking portion of mating member 114. Therefore, supporting arm 216 is fixedly connected with basement 11, and mounting bracket 21 can be fixed to basement 11 without cap 13 being connected to basement 11.

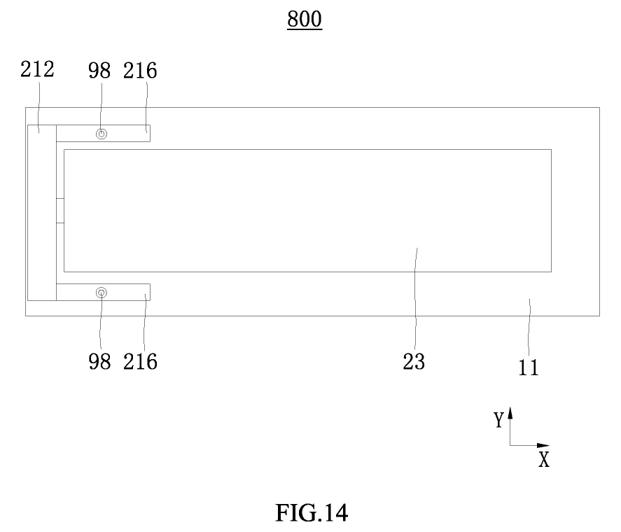

In some implementations, the at least one fastener assembly includes a screw thread assembly 98, as shown in FIG. 14. FIG. 14 illustrates a schematic block diagram of a cleaning assembly 800 with screw thread assembly 98, according to some aspects of the present disclosure. FIG. 14 is also a simplified version of schematic block diagram configured to illustrate the structure of the fastener assembly, and the details of cleaning assembly 800 are omitted for brevity. It should be understood that, other than screw thread assembly 98, cleaning assembly 800 may have the same or similar structure as cleaning assembly 200. The size and shape of the components of screw thread assembly 98 in FIG. 14 are illustrative and should not be limited to the implementations described herein, and any suitable structure can be applied to the present implementations with the teaching of the present disclosure.

Referring to FIG. 14, screw thread 98 may include a first through hole that penetrates supporting arm 216 and a second hole on basement 11 corresponding to the first through hole. Screw thread assembly 98 further includes a screw nut matching the first through hole with the second hole. When the screw nut goes through the first through hole and the second hole, supporting arm 216 is fixedly connected to basement 11. When the screw nut is taken out from the first through hole and the second hole, supporting arm 216 can be detached from basement 11.

FIGS. 9 - 14 illustrate six implementations employing different kinds of fastener assemblies configured to fixedly connect supporting arm 216 to basement 11 without cap 13 being connected with basement 11. It should be noted that more than one of the fastener assemblies described above can be combined with each other in some implementations. For example, the cleaning assembly may include at least two kinds of assemblies selected from the group of magnet assembly 60, rotatable fastener assembly 70, slotted fastener assembly 80, fastener assembly 90, or screw thread assembly 98. The fastener assembly can also include any other suitable structure that can fixedly connect supporting arm 216 with basement 11. It should be understood that the specific structures of the fastener assembly described herein should not limit the scope of the present disclosure, and any fastener assembly that can fixedly connect supporting arm 216 with basement 11 under the teaching of the present disclosure shall fall within the scope of the present disclosure.

In an aspect, embodiments of the present disclosure provide a suction chamber assembly for a cleaning device. The suction chamber assembly includes a suction chamber, a mounting bracket, and a roller brush. The suction chamber includes a basement connected to the cleaning device and a cap connected to the basement. The basement includes an outlet, and the cap includes an opening. The mounting bracket is detachably fixed to the suction chamber. The roller brush includes a fixing end connected with the mounting bracket and a free end extending opposite to the fixing end. The mounting bracket is fixed between the basement and the cap in the suction chamber by at least one pair of action force and reaction force applied between the mounting bracket and the suction chamber.

In some implementations, the suction chamber includes a first end through which the roller brush is connected to and a second end away from the first end along the first direction. The outlet is positioned adjacent to the second end.

In some implementations, the mounting bracket includes a mounting base detachably fixed in the suction chamber and at least one supporting arm extending from an edge of the mounting base along the first direction.

In some implementations, the suction chamber includes a first cavity positioned at the first end of the suction chamber and configured to accommodate the mounting base, at least one second cavity configured to accommodate the at least one supporting arm correspondingly, and a third cavity configured to accommodate the roller brush. The first cavity is formed by a first portion of the basement and a first portion of the cap, the second cavity is formed by a second portion of the basement and a second portion of the cap, and the third cavity is formed by sidewall of the basement and the sidewall of the cap.

In some implementations, the mounting base is fixed in the first cavity by a first pair of action-reaction forces, a first action force is generated from the mounting base and applied to the suction chamber, and a first reaction force is generated from the suction chamber and applied to the mounting base; or the at least one supporting arm is fixed in the second cavity by a second pair of action-reaction force, a second action force is generated from the at least one supporting arm and applied to the suction chamber, and a second reaction force is generated from the suction chamber and applied to the at least one supporting arm.

In some implementations, the first pair of action-reaction forces and the second pair of action-reaction forces are generated in response to the cap being connected with the basement and the at least one supporting arm being detachably fixed between the basement and the cap.

In some implementations, the basement is connected with the cap by a snap-fit member and a mating member of the snap-fit member mounted on the basement and the cap respectively and configured to fixedly couple the cap with the basement.

In some implementations, at least one flexible protrusion is disposed between the at least one supporting arm and the third cavity and is configured to enforce the action force and the reaction force.

In some implementations, the first pair of action-reaction forces and the second pair of action-reaction forces are generated in response to the supporting arm being detachably fixed with the basement by at least one fastener assembly.

In some implementations, the at least one fastener assembly includes a first magnet and a second magnet, or the first magnet and a metal member.

In some implementations, the first magnet includes permanent magnets.

In some implementations, the first magnet includes electromagnet.

In some implementations, the at least one fastener assembly further includes a control circuit connected with the first magnet and configured to adjust a magnetic force between the pair of magnet connectors by controlling a current flowing through the first magnet.

In some implementations, the at least one fastener assembly further includes a detector configured to detect a distance between the pair of magnet connectors, and a switch configured to automatically turn on the circuit in response to the distance being smaller than a threshold distance.

In some implementations, the fastener assembly includes a first fastener rotatably provided on the basement adjacent to a first side of the second portion of the basement, and a mating member corresponding to the first fastener and provided on the basement adjacent to a second side of the second portion of the basement.

In some implementations, the fastener assembly includes a pair of slots provided on the basement, and a second fastener configured to slide in the pair of slots. The corresponding supporting arm is positioned between the pair of slots. The second fastener is pressed against the corresponding supporting arm in response to the second fastener being positioned at a first end of the pair of slots. The second fastener is away from the corresponding supporting arm in response to the second fastener being positioned at a second end of the pair of slots.

In some implementations, the fastener assembly includes a third fastener on the supporting arm, and a mating member corresponding to the third fastener and provided on the basement.

In some implementations, the third fastener includes a spring portion and a rigid portion connected with the spring portion. The rigid portion is retracted into the supporting arm in response to the spring portion being compressed, and the rigid portion extends out of the supporting arm and is fixedly connected with the mating member corresponding to the third fastener in response to the spring portion being released.

In another aspect, embodiments of the present disclosure provide a suction chamber assembly for a cleaning device. The suction chamber assembly includes a suction chamber and a mounting bracket. The suction chamber includes a basement connected to the cleaning device and a cap connected to the basement. The basement includes an outlet, and the cap includes an opening. The mounting bracket includes a mounting base detachably fixed in the suction chamber, and at least one supporting arm extending from an edge of the mounting base along the first direction. The at least one supporting arm is detachably fixed between the basement and the cap in the suction chamber by at least one pair of action force and reaction force applied between the basement of the suction chamber and at least one supporting arm.

In yet another aspect, embodiments of the present disclosure also provide a cleaning device. The cleaning device includes a chassis, a suction chamber connected to the chassis, a mounting bracket, and a roller brush. The suction chamber includes a basement connected to the cleaning device and a cap connected to the basement. The basement includes an outlet, and the cap includes an opening. The mounting bracket includes a mounting base detachably fixed in the suction chamber, and at least one supporting arm extending from an edge of the mounting base along the first direction. The roller brush includes a fixing end connected with the mounting bracket and a free end extending opposite to the fixing end. The mounting bracket is fixed between the basement and the cap in the suction chamber by at least one pair of action force and reaction force applied between the mounting bracket and the basement of the suction chamber.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations but should be defined only in accordance with the following claims and their equivalents.

What is claimed is:

1. A cantilever roller brush assembly for a cleaning device, comprising:
a mounting bracket;
a cantilever roller brush comprising a fixing end and a free end, the fixing end of the cantilever roller brush rotatably connected to the mounting bracket, and the free end of the cantilever roller brush extending from the fixing end of the cantilever roller brush along the length direction of the cantilever roller brush;
the cantilever roller brush assembly detachably fixed in the cleaning device through the mounting bracket.

2. The cantilever roller brush assembly according to claim 1, wherein
the cleaning device comprises a suction chamber, the cantilever roller brush assembly is detachably fixed in the suction chamber through the mounting bracket;
the suction chamber comprises a basement and a cap, and the cap has an opening state and a close state relative to the basement;
the cantilever roller brush assembly can be removed from the suction chamber when the cap is in the opening state; and
the cantilever roller brush assembly can be fixedly connected with the suction chamber when the cap is in the close state.

3. The cantilever roller brush assembly according to claim 2, wherein
the mounting bracket comprises a mounting base;
the suction chamber comprises a first cavity and a third cavity;
the first cavity is configured to accommodate the mounting base, the first cavity is formed by a first portion of the basement and a first portion of the cap; the mounting base is confined and fixed by the first cavity when the cantilever roller brush assembly is mounted in the suction chamber and the cap is in the close state;
the third cavity is configured to accommodate the cantilever roller brush, the third cavity is formed by a sidewall of the basement and a sidewall of the cap, the cantilever roller brush is rotatably positioned in the third cavity when the cantilever roller brush assembly is mounted in the suction chamber and the cap is in the close state.

4. The cantilever roller brush assembly according to claim 3, wherein
the first portion of the basement and the first portion of the cap are both a concave portion; and/or
the first cavity has the same shape as the mounting base.

5. The cantilever roller brush assembly according to claim 3, wherein
the mounting bracket comprises at least one supporting arm, the at least one supporting arm is connected to the mounting base;
the suction chamber comprises at least one second cavity;
the at least one second cavity is configured to accommodate the at least one supporting arm correspondingly, the second cavity is formed by a second portion of the basement and a second portion of the cap, the at least one supporting arm is confined and fixed by the second cavity when the cantilever roller brush assembly is mounted in the suction chamber and the cap is in the close state.

6. The cantilever roller brush assembly according to claim 5, wherein
the second portion of the basement and the second portion of the cap are both a concave portion, or the second portion of the basement is a slot, and the second portion of the cap is as flat as a second side of supporting arm; and/or,
the second portion of the basement is a slot, and the slot comprises a bottom surface located at a bottom of the slot and two side surfaces extending from the bottom surface to a top of the slot.

7. The cantilever roller brush assembly according to claim 5, wherein
the suction chamber further comprises at least one flexible protrusion, the flexible protrusion is disposed between the supporting arm and the suction chamber when the basement is connected to the cap; or,
the suction chamber further comprises at least one flexible protrusion, the flexible protrusion is disposed between the supporting arm and the suction chamber when the cap is in the close state relative to the basement.

8. The cantilever roller brush assembly according to claim 7, wherein
the flexible protrusion is provided on any one of the second portion of the basement, the second portion of the cap, or the supporting arm, so that the flexible protrusion is positioned between the supporting arm and the second portion of the cap or between the supporting arm and the second portion of the basement; or,
two or more flexible protrusions are disposed on both sides of the supporting arm.

9. The cantilever roller brush assembly according to claim 5, wherein
the first cavity and the second cavity are connected to each other to accommodate the mounting base and the supporting arm as a whole; and/or,
the second cavity has the same shape as the supporting arm.

10. The cantilever roller brush assembly according to claim 5, wherein
the mounting base is fixed in the first cavity by a first pair of action-reaction forces, a first action force is generated from the mounting base and applied to the suction chamber, and a first reaction force is generated from the suction chamber and applied to the mounting base; and/or,
the at least one supporting arm is fixed in the second cavity by a second pair of action-reaction force, a second action force is generated from the at least one supporting arm and applied to the suction chamber, and a second reaction force is generated from the suction chamber and applied to the at least one supporting arm.

11. The cantilever roller brush assembly according to claim 2, wherein the basement is connected with the cap by:
a snap-fit member and a mating member of the snap-fit member mounted on the basement and the cap respectively and configured to fixedly connect the cap with the basement.

12. The cantilever roller brush assembly according to claim 1, wherein
the cleaning device comprises a suction chamber, the cantilever roller brush assembly is detachably fixed in the suction chamber through the mounting bracket, the suction chamber comprises a basement;
the mounting bracket comprises a mounting base and at least one supporting arm, the supporting arm is detachably fixed with the basement by at least one fastener assembly.

13. The cantilever roller brush assembly according to claim 12, wherein
the at least one fastener assembly comprises at least one of magnet assembly, rotatable fastener assembly, slotted fastener assembly, spring fastener assembly, and screw thread assembly;
the magnet assembly comprises a first magnetic disposed on the basement and a second magnetic disposed on the mounting base;
the rotatable fastener assembly comprises a first fastener and a mating member corresponding to the first fastener, one of the first fastener and the corresponding mating member is disposed on the basement, and adjacent to a first side of the second portion of the basement, and another is disposed on the basement, and adjacent to a second side of the second portion of the basement; the first fastener is rotatable disposed and freely rotates to approach or move away from the corresponding mating member of the first fastener, the corresponding supporting arm is locked by the first fastener when the first fastener is combined with the corresponding mating member of the first fastener, and the supporting arm is removed when the first fastener disengages from the corresponding mating member of the first fastener;
the slotted fastener assembly comprises a pair of slots provided on the basement and a second fastener configured to slide into the pair of slots, the supporting arm is positioned between the pair of slots, when the second fastener is positioned at a first end of the slot, the second fastener is pressed against the corresponding supporting arm, when the second fastener is positioned at a second end of the slot, the second fastener is away from the corresponding supporting arm;
the spring fastener assembly comprises a third fastener positioned on the supporting arm and a mating member corresponding to the third fastener and positioned on the basement, the third fastener comprises a rigid portion and a spring connected with the rigid portion, the rigid portion is retracted into the supporting arm when the spring is compressed; and the rigid portion extends out of the supporting arm and is fixedly connected with the mating member on the basement when the spring is released;
the screw thread assembly comprises a first through hole that penetrates the supporting arm, a second through hole on basement corresponding to the first through hole, and a screw nut matching the first through hole and the second through hole; the supporting arm is fixedly connected to the basement when the screw nut goes through the first through hole and the second through hole, and the supporting arm is detached from the basement when the screw nut is taken out from the first through hole and the second through hole.

14. The cantilever roller brush assembly according to claim 1, wherein
the mounting bracket comprises a mounting base and at least one supporting arm, along the length direction of the cantilever roller brush, the supporting arm extends from an edge of the mounting base; and/or,
the mounting bracket comprises a mounting base and at least one supporting arm, along the length direction of the cantilever roller brush, the supporting arm extends from an edge of the mounting base towards the free end of the cantilever roller brush; and/or,
the mounting bracket comprises a mounting base and at least one supporting arm, the at least one supporting arm can rotate in the circumferential direction around the cantilever roller brush; and/or,
the mounting bracket comprises a mounting base and at least one supporting arm, a ratio of the length of the supporting arm to the length of the cantilever roller brush is between 1:1 and 1:10; and/or,
the mounting bracket comprises a mounting base and at least one supporting arm, one end of the supporting arm is integrally formed with the mounting base; and/or,
the mounting bracket comprises a mounting base and at least one supporting arm, along the length direction of the cantilever roller brush, the corresponding roller brush within the length range of the supporting arm can contact a surface to be cleaned.

15. The cantilever roller brush assembly according to claim 14, wherein a number of the supporting arm is two,
two supporting arms are symmetrically arranged relative to a centerline of the mounting base, and the centerline of the mounting base extends along the length direction of the cantilever roller brush; and/or,
the lengths of the two supporting arms are equal; and/or,
the two supporting arms are parallel to each other.

16. The cantilever roller brush assembly according to claim 14, wherein
the basement comprises an outlet, the outlet is connected to a collector of the cleaning device; the cap comprises an opening, and the cantilever roller brush contacts a surface to be cleaned through the opening.

17. The cantilever roller brush assembly according to claim 16, wherein
the free end of the cantilever roller brush is closer to the outlet than a fixing end; or,
the suction chamber comprises a first end and a second end located away from the first end along the length direction of the cantilever roller brush, the cantilever roller brush is connected to the suction chamber through the first end, and the outlet is located near the second end.

18. The cantilever roller brush assembly according to claim 2, wherein
the cap rotates relative to the basement between a close state and an opening state; or,
the cap can be removed from the basement; or,
the cap can be removed from the basement, the cap is in the close state relative to the basement when the cap is mounted on the basement; the cap is in the opening state relative to the basement when the cap is removed from the basement.

19. A cleaning device comprising a suction chamber and a cantilever roller brush assembly as claimed in claim 1, wherein the cantilever roller brush assembly is detachably fixed in the suction chamber.
